(19) United States
(12) Patent Application Publication
(10) Pub. No.: US 2026/0364997 A1
(43) Pub. Date: Nov. 19, 2026

(54) ELECTRIC VEHICLE CABIN HEATING USING BRAKE WASTE HEAT

(71) Applicant: GM Global Technology Operations LLC, Detroit, MI (US)

(72) Inventors: Hyunggyu Chang, Gyeonggi-do (KR); Bongbum Back, Incheon (KR); Seokju Yong, Bucheon-si (KR); Hyoungjun Choi, Incheon (KR); Taekyung Kim, Seongnam-si (KR); James A. Webster, Bloomfield Hills, MI (US)

(73) Assignee: GM Global Technology Operations LLC, Detroit, MI (US)

(21) Appl. No.: 19/209,994

(22) Filed: May 16, 2025

(51) Int. Cl. B60H 1/03

(52) U.S. Cl. CPC B60H 1/03

(57) ABSTRACT

A method includes determining that a heating ventilation and cooling (HVAC) system of a vehicle is turned on to heat air in a cabin of the vehicle. The method also includes determining that an outside temperature satisfies a criterion. Based on the HVAC system being turned on and the outside temperature satisfying the criterion, the method includes activating a blower of the vehicle to move air heated by waste heat associated with one or more brakes of the vehicle through one or more respective air passageways to transfer the waste heat from the one or more brakes to the HVAC system for heating the air in the cabin, and deactivating an electric heater of the HVAC system

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The driving range of an electric vehicle (EV) may be reduced in cold weather due to a need to operate an electric heater for heating air in a cabin of the vehicle. The present disclosure relates generally to EV cabin heating using brake waste heat.

### SUMMARY

An aspect of the disclosure provides a vehicle including a cabin configured to accommodate an operator of the vehicle, a plurality of wheels, a plurality of brakes for respective ones of the plurality of wheels, a heating ventilation and cooling (HVAC) system configured to at least heat air in the cabin, one or more air passageways defined between respective ones of one or more of the brakes and the HVAC system, and a blower. Each brake is configured to, in response to an operator input, slow a rotation of a respective wheel, and wherein each brake heats up while slowing the rotation of the respective wheel. The blower is configured to move air heated by waste heat of the one or more brakes through the one or more air passageways to provide the waste heat from the one or more brakes to the HVAC system for heating the air in the cabin.

Implementations of the disclosure may include one or more of the following optional features. In some implementations, the vehicle also includes one or more filters, wherein each filter is configured to filter the air passing through a respective air passageway. In some examples, the one or more filters are configured to at least remove brake dust. In some configurations, the vehicle also includes one or move valves, wherein each valve is configured to permit or prevent air from passing through a respective air passageway.

In some examples, the heated air passing through the one or more air passageways to the HVAC system heats an HVAC manifold or an HVAC heat exchanger that is configured to transfer the waste heat from the one or more brakes to the air in the cabin. In some configurations, the heated air passing through the one or more air passageways to the HVAC system is passed through the HVAC system into the cabin to heat the air in the cabin.

In some implementations, each of the one or more air passageways includes an insulated flexible air hose having an intake end in a vicinity of a respective brake. In some examples, each brake includes a brake pad dust collector system configured to provide a space for the waste heat from the brake to be transferred to the air passing through a respective air passageway. In some configurations, each brake is part of an in-wheel drive system configured to rotate a respective wheel.

In some examples, the vehicle also includes a controller configured to perform operations including determining that the HVAC system is turned on to heat the air in the cabin, determining that an outside temperature satisfies a criterion, and, based on the HVAC system being turned on and the outside temperature satisfying the criterion, activating the blower. In some configurations, the operations also include, based on the HVAC system being turned on and the outside temperature satisfying the criterion, deactivating an electric heater of the HVAC system. In some implementations, the operations also include, based on the HVAC system being turned on and the outside temperature satisfying the criterion, deactivating regenerative braking.

Another aspect of the disclosure provides a method including determining that a heating ventilation and cooling (HVAC) system of a vehicle is turned on to heat air in a cabin of the vehicle, and determining that an outside temperature satisfies a criterion. The method also includes, based on the HVAC system being turned on and the outside temperature satisfying the criterion: activating a blower of the vehicle to move air heated by waste heat associated with one or more brakes of the vehicle through one or more respective air passageways to transfer the waste heat from the one or more brakes to the HVAC system for heating the air in the cabin; and deactivating an electric heater of the HVAC system.

Implementations of the disclosure may include one or more of the following optional features. In some implementations, the method also includes, based on the HVAC system being turned on and the outside temperature satisfying the criterion, opening one or more valves for respective ones of the one or more air passageways. In some examples, the method also includes, based on the HVAC system being turned on and the outside temperature satisfying the criterion, deactivating an electric heater of the HVAC system. In some configurations, the method also includes, based on the HVAC system being turned on and the outside temperature satisfying the criterion, deactivating regenerative braking.

Yet another aspect of the disclosure provides a system including data processing hardware, and memory hardware in communication with the data processing hardware and storing instructions that, when executed by the data processing hardware, causes the data processing hardware to perform operations. The operations include determining that a heating ventilation and cooling (HVAC) system of a vehicle is turned on to heat air in a cabin of the vehicle, and determining that an outside temperature satisfies a criterion. The operations also include, based on the HVAC system being turned on and the outside temperature satisfying the criterion: activating a blower of the vehicle to move air heated by waste heat associated with one or more brakes of the vehicle through one or more respective air passageways to transfer the waste heat from the one or more brakes to the HVAC system for heating the air in the cabin; and deactivating an electric heater of the HVAC system.

Implementations of the disclosure may include one or more of the following optional features. In some implementations, the operations also include, based on the HVAC system being turned on and the outside temperature satisfying the criterion, opening one or more valves for respective ones of the one or more air passageways. In some examples, the operations also include, based on the HVAC system being turned on and the outside temperature satisfying the criterion, deactivating an electric heater of the HVAC system. In some configurations, the operations also include, based on the HVAC system being turned on and the outside temperature satisfying the criterion, deactivating regenerative braking.

### BRIEF DESCRIPTION OF THE DRAWINGS

The drawings described herein are for illustrative purposes only of selected configurations and are not intended to limit the scope of the present disclosure.

FIG. 1 is a view of an example electric vehicle (EV) including a heating, cooling, and ventilation (HVAC) system in accordance with the principles of the present disclosure.

FIG. 2 is a schematic view of the HVAC system of FIG. 1.

FIG. 3 is a view of an example of the HVAC system of FIG. 2.

FIG. 4 is a view of an example brake pad dust collection system.

FIG. 5 is a flowchart of an example arrangement of operations for EV cabin heating using brake heat.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM) / erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

The driving range of an electric vehicle (EV) may be reduced (e.g., by 30 or 40 percent) in cold weather due to a need to operate an electric heater for heating air in a cabin of the vehicle. The reduction in driving range may lower the marketability of EVs, increase customer complaints, or increase customer dissatisfaction. Therefore, there is a need for systems that can heat the air in a cabin of an EV without consuming electrical power for powering an electric heater. In disclosed configurations, waste heat from brakes is used to heat air in a cabin of an EV. In particular, disclosed systems capture waste heat generated by the friction brake system attached to each wheel and draw the captured waste heat into the vehicle's heating, ventilation, and cooling (HVAC) system to heat air in the vehicle's cabin. Disclosed systems can result in substantial improvements in an EV's driving range in cold conditions.

While examples are shown and described herein in connection with a vehicle (e.g., an automobile, a truck, an airplane, a train, a motorcycle, etc.), it should be understood that disclosed configurations may additionally, or alternatively, be used for capturing waste heat and using captured waste heat to heat air in a portion of any other type of device (e.g., construction equipment, industrial equipment, etc.).

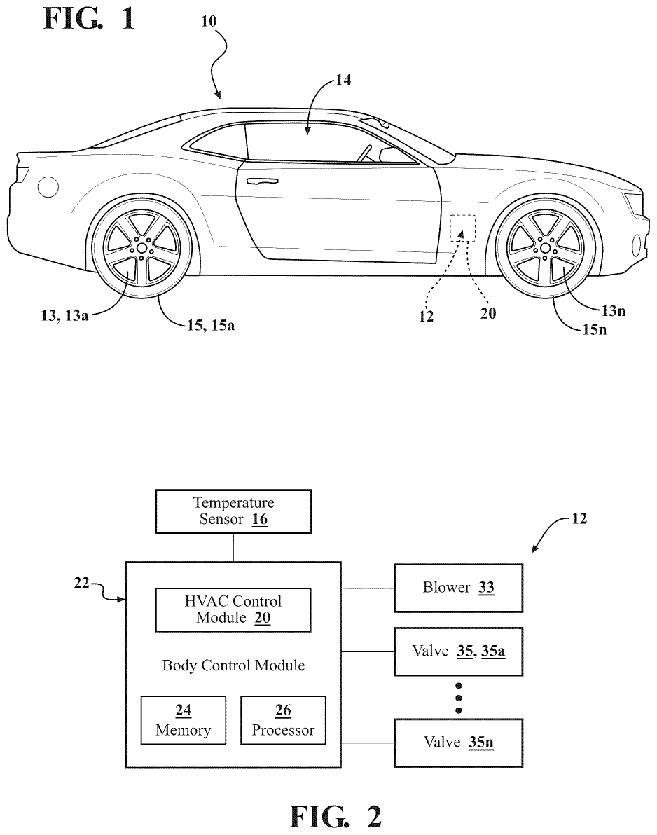

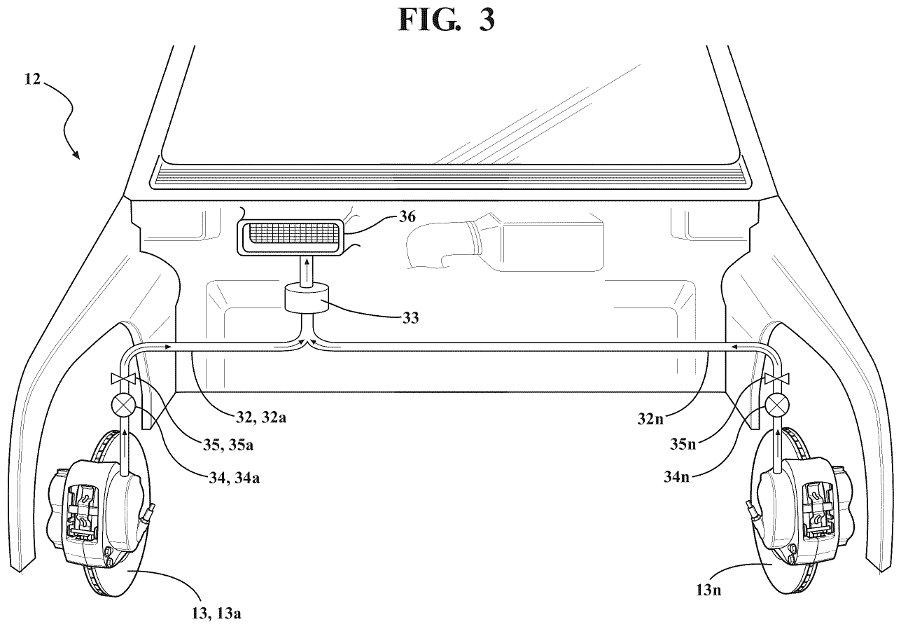

With particular reference to FIGS. 1, 2, and 3, a vehicle 10 (e.g., an automobile, a truck, an airplane, a train, a motorcycle, etc.) is shown in conjunction with an HVAC system 12 for capturing waste heat generated by brakes 13, 13a-n of the vehicle 10 and using the captured waste heat to heat air in a cabin 14 of the vehicle 10, or to heat any other portion(s) of the vehicle 10. Here, the cabin 14 is configured to accommodate an operator of the vehicle 10. In the illustrated example, each brake 13 is associated with a respective wheel 15, 15a-n of the vehicle 10. Each brake 13 is configured to, responsive to operator input, slow the rotation of a respective wheel 15 to slow or stop a movement of the vehicle 10. Depending upon operator input and operating conditions, only some of the brakes 13 may be activated at a given time. Here, as a brake 13 slows the rotation of a respective wheel 15, the brake 13, or a portion thereof (e.g., a rotor), may heat up due to, for example, friction.

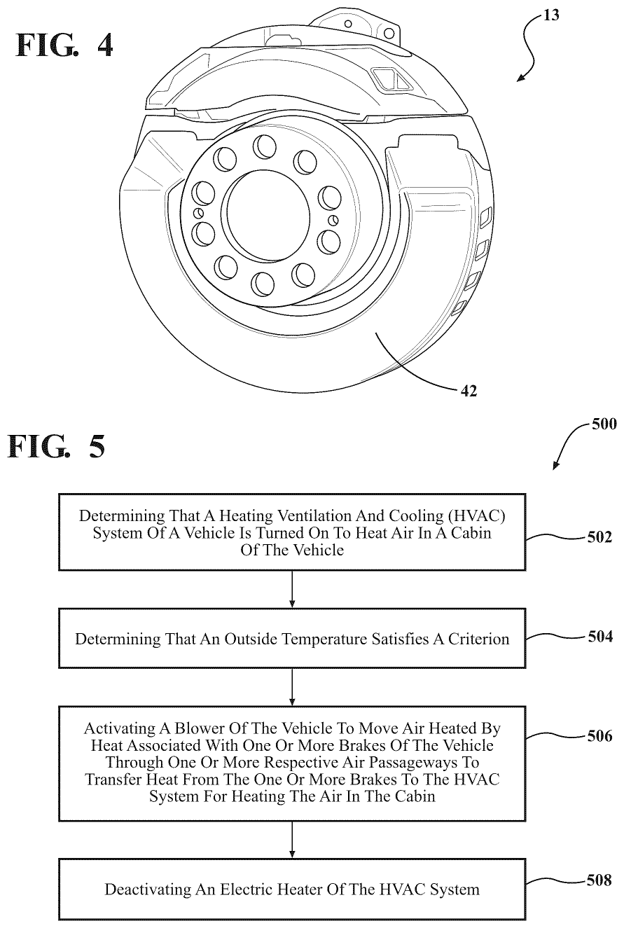

The HVAC system 12 is configured to at least heat air in the cabin 14 using an electric heater or waste heat captured from the brakes 13, or a subset of the brakes 13 (e.g., front brakes 13). The HVAC system 12 includes one or more air passageways 32, 32a-n defined between the brakes 13, or the subset of brakes 13, and the HVAC system 12. For example, there may be one air passageway 32 per brake 13, or the air passageways 32 may be connected in a tree-like structure between the brakes 13 and the HVAC system 12. In some examples, the air passageways 32 are formed using insulated flexible air hoses having an intake end in a vicinity of a respective brake 13. In some implementations, each brake 13 includes a brake pad dust collector system 42 (see FIG. 4). Here, the intake end of an air passageway 32 may be connected to the brake pad dust collector system 42 to capture air that is heated in a space between the brake 13 and the brake pad dust collector system 42. In other implementations, each brake 13 is part (e.g., an in-wheel brake caliper) of an in-wheel drive system having an electric motor configured to rotate a respective wheel 15.

The HVAC system 12 also includes one or more blowers 33 configured to move air heated by waste heat of the one or more brakes 13 (e.g., front brakes 13) through the one or more air passageways 32 to provide heat from the one or more brakes 13 to the HVAC system 12 for heating the air in the cabin 14. In some implementations, the heated air passing through the one or more air passageways 32 to the HVAC system 12 heats an HVAC manifold or heat exchanger 36 that is configured to indirectly transfer heat from the one or more brakes 13 to the air in the cabin 14. Additionally, or alternatively, the heated air passing through the one or more air passageways 32 to the HVAC system 12 may be passed through the HVAC system 12 into the cabin 14 to heat the air in the cabin 14.

In some examples, the HVAC system 12 includes one or more filters 34, 34a-n. Here, each filter 34 is configured to filter the air passing through a respective air passageway 32. However, a filter 34 may be used to filter air from multiple brakes 13. In some implementations, the one or more filters 34 are configured to at least remove brake dust.

In some implementations, the HVAC system 12 includes one or move valves 35, 35a-n. Here, each valve 35 is selectively configurable (e.g., by an HVAC control module 20) to permit or prevent air from passing through a respective air passageway 32.

The HVAC system 12 also includes an HVAC control module 20 for controlling the HVAC system 12. The HVAC control module 20 may be executed on, for example, a body control module (BCM) 22 or any other controller or control module of the vehicle 10. The BCM controller 22 stores machine-readable instructions for executing the HVAC control module 20 on, for example, memory hardware 24 (e.g., a memory). The instructions may be executed by data processing hardware 26 (e.g., a processor) of the BCM controller 22 to execute the HVAC control module 20. Here, the HVAC control module 20 may perform the operations shown in FIG. 5, or operations described elsewhere in the present disclosure.

The HVAC control module 20 is configured to perform operations including determining that the HVAC system 12 is turned on to heat air in the cabin 14, determining (e.g., using a temperature sensor 16) that an outside temperature satisfies a criterion (e.g., is less than 5 °C), and, based on the HVAC system 12 being turned on and the outside temperature satisfying the criterion, opening the valves 35 and activating the blower 33 to move air heated by waste heat of the one or more brakes 13 through the one or more air passageways 32 to provide waste heat from the one or more brakes 13 to the HVAC system 12 for heating the air in the cabin 14.

In some examples, when the HVAC control module 20 activates the blower 33, the HVAC control module 20 deactivates an electric heater of the HVAC system 12. In some implementations, when the HVAC control module 20 activates the blower 33, the HVAC control module 20 controls, for example, a power-inverter module to deactivate or disable regenerative braking.

FIG. 5 is a flowchart of an example arrangement of operations for providing a park-assist mode. The operations may be performed by data processing hardware (e.g., the data processing hardware 26) based on executing instructions stored on memory hardware (e.g., the memory hardware 24). Many other ways of implementing the method 500 may be employed. For example, the order of execution of the operations may be changed, and/or one or more of the operations and/or interactions may be changed, eliminated, sub-divided, or combined. Additionally, the operations of FIG. 5 may be carried out sequentially and/or in parallel by, for example, separate processing threads, processors, devices, discrete logic, circuits, etc.

At operation 502, the method 500 includes determining that a heating ventilation and cooling (HVAC) system 12 of a vehicle 10 is turned on to heat air in a cabin 14 of the vehicle 10. At operation 504, the method 500 includes determining that an outside temperature satisfies a criterion (e.g., is less than 5 °C).

At operation 506, based on the HVAC system 12 being turned on and the outside temperature satisfying the criterion, the method 500 includes activating a blower 33 of the vehicle 10 to move air heated by waste heat associated with one or more brakes 13 of the vehicle 10 through one or more respective air passageways 32 to transfer heat from the one or more brakes 13 to the HVAC system 12 for heating the air in the cabin 14. At operation 508, the method 500 includes deactivating an electric heater of the HVAC system 12.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a cabin configured to accommodate an operator of the vehicle;
a plurality of wheels;
a plurality of brakes for respective ones of the plurality of wheels, wherein each brake is configured to, in response to an operator input, slow a rotation of a respective wheel, and wherein each brake heats up while slowing the rotation of the respective wheel;
a heating ventilation and cooling (HVAC) system configured to at least heat air in the cabin;
one or more air passageways defined between respective ones of one or more of the brakes and the HVAC system; and
a blower configured to move air heated by waste heat of the one or more brakes through the one or more air passageways to provide the waste heat from the one or more brakes to the HVAC system for heating the air in the cabin.

2. The vehicle of claim 1, further comprising one or more filters, wherein each filter is configured to filter the air passing through a respective air passageway.

3. The vehicle of claim 2, wherein the one or more filters are configured to at least remove brake dust.

4. The vehicle of claim 1, further comprising one or move valves, wherein each valve is configured to permit or prevent air from passing through a respective air passageway.

5. The vehicle of claim 1, wherein the heated air passing through the one or more air passageways to the HVAC system heats an HVAC manifold or an HVAC heat exchanger that is configured to transfer the waste heat from the one or more brakes to the air in the cabin.

6. The vehicle of claim 1, wherein the heated air passing through the one or more air passageways to the HVAC system is passed through the HVAC system into the cabin to heat the air in the cabin.

7. The vehicle of claim 1, wherein each of the one or more air passageways comprises an insulated flexible air hose having an intake end in a vicinity of a respective brake.

8. The vehicle of claim 1, wherein each brake includes a brake pad dust collector system configured to provide a space for the waste heat from the brake to be transferred to the air passing through a respective air passageway.

9. The vehicle of claim 1, wherein each brake is part of an in-wheel drive system configured to rotate a respective wheel.

10. The vehicle of claim 1, further comprising a controller configured to perform operations comprising:
determining that the HVAC system is turned on to heat the air in the cabin;
determining that an outside temperature satisfies a criterion; and
based on the HVAC system being turned on and the outside temperature satisfying the criterion, activating the blower.

11. The vehicle of claim 10, wherein the operations further comprise, based on the HVAC system being turned on and the outside temperature satisfying the criterion, deactivating an electric heater of the HVAC system.

12. The vehicle of claim 10, wherein the operations further comprise, based on the HVAC system being turned on and the outside temperature satisfying the criterion, deactivating regenerative braking.

13. A method comprising:
determining that a heating ventilation and cooling (HVAC) system of a vehicle is turned on to heat air in a cabin of the vehicle;
determining that an outside temperature satisfies a criterion; and
based on the HVAC system being turned on and the outside temperature satisfying the criterion:
activating a blower of the vehicle to move air heated by waste heat associated with one or more brakes of the vehicle through one or more respective air passageways to transfer the waste heat from the one or more brakes to the HVAC system for heating the air in the cabin; and
deactivating an electric heater of the HVAC system.

14. The method of claim 13, further comprising, based on the HVAC system being turned on and the outside temperature satisfying the criterion, opening one or more valves for respective ones of the one or more air passageways.

15. The method of claim 13, further comprising, based on the HVAC system being turned on and the outside temperature satisfying the criterion, deactivating an electric heater of the HVAC system.

16. The method of claim 13, further comprising, based on the HVAC system being turned on and the outside temperature satisfying the criterion, deactivating regenerative braking.

17. A system comprising:
data processing hardware; and
memory hardware in communication with the data processing hardware and storing instructions that, when executed by the data processing hardware, causes the data processing hardware to perform operations comprising:
determining that a heating ventilation and cooling (HVAC) system of a vehicle is turned on to heat air in a cabin of the vehicle;
determining that an outside temperature satisfies a criterion; and
based on the HVAC system being turned on and the outside temperature satisfying the criterion:
activating a blower of the vehicle to move air heated by waste heat associated with one or more brakes of the vehicle through one or more respective air passageways to transfer the waste heat from the one or more brakes to the HVAC system for heating the air in the cabin; and
deactivating an electric heater of the HVAC system.

18. The system of claim 17, wherein the operations further comprise, based on the HVAC system being turned on and the outside temperature satisfying the criterion, opening one or more valves for respective ones of the one or more air passageways.

19. The system of claim 17, wherein the operations further comprise, based on the HVAC system being turned on and the outside temperature satisfying the criterion, deactivating an electric heater of the HVAC system.

20. The system of claim 17, wherein the operations further comprise, based on the HVAC system being turned on and the outside temperature satisfying the criterion, deactivating regenerative braking.
